(19) United States
(12) Patent Application Publication
(10) Pub. No.: US 2013/0306695 A1
(43) Pub. Date: Nov. 21, 2013

(54) Arrangement For Mounting A Tank To A Vehicle

(71) Applicant: Westport Power Inc., Vancouver (CA)

(72) Inventors: Paul G. Guaresimo, Grosse Pointe Woods, MI (US); William G. Szuch, Goodison, MI (US)

(21) Appl. No.: 13/897,033

(22) Filed: May 17, 2013

Related U.S. Application Data
(60) Provisional application No. 61/649,233, filed on May 18, 2012.

(51) Int. Cl. B60R 9/00

(52) U.S. Cl. CPC B60R 9/00
USPC 224/567

(57) ABSTRACT

An arrangement for mounting a tank to a vehicle provides a support structure that can be employed in the same mounting location to mount tanks of different dimensions. The support structure comprises at least one support bracket mounted on a vehicle body. The support bracket comprising two mounting points spaced apart from each other and spaced from the vehicle body. A strap that is tightened to clamp around the tank has two mounts spaced along the length of the strap to connect to the two mounting points respectively. Some rotational movement is allowed where the mounts connect to the mounting points to accommodate tanks with different cross-sectional dimensions.

### CROSS-REFERENCE TO RELATED APPLICATION

This application is a related to and claims priority benefits from U.S. Provisional Patent Application Ser. No. 61/649,233, filed on May 18, 2012, entitled “Arrangement for Mounting a Tank to a Vehicle”. The '233 provisional application is hereby incorporated by reference herein in its entirety.

### FIELD OF THE INVENTION

The present invention relates to an arrangement for mounting a tank to a vehicle, and more specifically to an arrangement for mounting a tank in a pick-up truck bed.

### BACKGROUND OF THE INVENTION

Presently, most over-the-road vehicles are fuelled by gasoline or diesel fuel. There are certain shortcomings to using such fuels. They are increasingly expensive and they have an adverse impact on the environment because combustion products exhausted into the atmosphere are environmentally undesirable.

It is known that internal combustion engines can operate efficiently with reduced levels of pollutants in the engine exhaust if fuelled with natural gas or other combustible gaseous fuels, such as methane, propane, butane, hydrogen, and blends of such fuels. For vehicles fuelled with both gasoline and natural gas, for example, auxiliary fuel tanks filled with compressed natural gas (CNG) can be placed in the trunk or other storage areas of the vehicle and can be connected with the vehicle's fuel system for supplying fuel to the engine. Storing fuel in auxiliary fuel tanks on board a vehicle is limited by the available storage areas and in turn, the available fuel storage volume affects the distance that the vehicle can travel.

Fuel tanks have generally been supported on board of heavy vehicles by L- or J-brackets attached to the side of the chassis frame. In some other vehicles, CNG tanks can be installed to the underside of the vehicle as described, for example, in U.S. Pat. No. 5,810,309 which illustrates a pair of mounting brackets, each bracket comprising a cylinder brace with a pair of clamping bands for supporting the CNG tank. In smaller vehicles, the CNG tank can be mounted in the vehicle's trunk as described in U.S. Pat. No. 6,042,071 which illustrates a structure for supporting a CNG tank comprising a pair of supporting frame members fixed on the car body and a fixing band connected to each of the frame members for securing the tank thereto. Each fixing band has several band sections clamped together through a bolt and spring arrangement. The advantage of such a mounting arrangement is that due to the elastic deformation of the spring, the fixing band can accommodate expansion of the fuel tank during operation.

For pick-up trucks, auxiliary CNG tanks can be installed in the truck's bed. In this disclosure, the “bed” of a pick-up truck, which is sometimes also known as the “box” is defined to be the part of the vehicle body that comprises a floor, a front panel next to the cab, two opposing bed sides and a tail-gate at the rear of the vehicle. Depending on the vehicle specification and the distance that the vehicle has to travel, different customers may require different sized CNG tanks. Therefore, it is advantageous if a vehicle manufacturer can employ one arrangement for mounting a tank that can accommodate the installation of different sized CNG tanks.

In the existing prior art, tank mounting arrangements allow the installation of fuel tanks of the same size. U.S. Pat. No. 6,042,071 addresses the problem of allowing some flexibility of the tank mounting arrangement for accommodating some expansion of the fuel tank, but it does not address the problem of allowing the replacement of one fuel tank with one of a different size.

Accordingly, there is a need for an improved mounting arrangement for securely mounting a tank on a vehicle body and allowing the installation of tanks of different cross-sectional dimensions.

### SUMMARY OF THE INVENTION

A tank mounting arrangement is disclosed for supporting tanks of different cross-sectional dimensions on a vehicle body. The tank mounting arrangement comprises at least one supporting structure mounted on the vehicle body adjustable to support tanks of different cross-sectional dimensions, each supporting structure being connected to a strap in two mounting locations spaced transversal to a longitudinal axis of a tank wherein the strap encircles the tank to secure it to the supporting structure.

Each of the supporting structures comprises at least one member having a portion that projects from the vehicle body whereby at least one of the mounting locations is spaced from the vehicle body. In preferred embodiments, both mounting locations are spaced from the vehicle body, whereby the strap securing the tank to the supporting structure is in contact with the entire circumference of the tank and the tank is held spaced from the vehicle body.

Each of the straps which encircle the tank comprises a mount extending radially from the tank when the tank is mounted on the supporting structure for connecting the strap to the supporting structure at the mounting location. The mounts can be for example U-shaped members which are attached to each strap and connect the strap to the supporting structure when the strap is installed thereon.

In preferred embodiments, each strap is connected to a respective supporting structure through mounts which allow some degree of rotation of the strap relative to the supporting structure at the mounting location to accommodate tanks of different cross-sectional dimensions. The rotation at the mounting location can be provided by each mount comprising a U-shaped member and a bolt or a pin which connects the U-shaped member with the tank supporting structure.

Each of the straps which encircle the tank comprises a tightening device for tensioning the strap such that the strap secures the tank on the supporting structure.

Generally, when a tank is installed on the vehicle body the distance between the bottom of the tank and a surface of the vehicle body on which the tank is mounted is larger than a minimum predetermined distance.

In preferred embodiments, the tank is a pressure vessel for storing an auxiliary fuel such as compressed natural gas. The tank can be installed through the present tank mounting arrangement on the floor of a pick-up truck bed. In some embodiments the supporting structures of the present tank arrangement can be secured to structural members of the frame of a pick-up truck.

In preferred embodiments, the distance between the tank supporting structures when they are mounted on the vehicle body is selected to accommodate tanks of different lengths.

In some embodiments, the shape of the supporting structures is adapted to conform to the shape of the tank. The supporting structures can be shaped to be spaced apart from the tank whereby the strap securing the tank to the supporting structure is in contact with the tank but it is not in contact with the supporting structure.

A method is provided for using the same apparatus for mounting tanks of different cross-sectional dimensions on a vehicle body, for example in a pick-up truck bed. The method comprises:
(a) detachably mounting at least one tank strap on at least one supporting structure which is mounted on the vehicle body wherein each strap is mounted in two mounting locations on the supporting structure;
(b) placing a tank on the strap and wrapping the strap around the tank whereby the tank strap can rotate at the mounting locations to conform to the shape of the tank; and
(c) operating a tightening device associated with each strap to tighten the strap and secure the tank in a mounted position on the supporting structure; and
(d) following the same steps using the same supporting structure to mount a tank with a different cross-sectional dimension.

The method can further comprise using different straps for different tank sizes whereby the length of the strap is matched to the circumference of the tank.

The method can further comprise using different straps for different tank sizes whereby linear spacing between mounts is matched to tank size such that a desired spacing is achieved between the bottom of the tank and the vehicle body.

### BRIEF DESCRIPTION OF THE DRAWINGS

FIG. 1 is a view of a first embodiment of two tank supporting brackets installed on the floor of a pick-up truck bed.

FIG. 2 shows the first embodiment of the tank supporting brackets and the straps for securing a tank to the supporting brackets.

FIG. 3 is a view of a cylindrically shaped tank secured by straps to the supporting brackets of the disclosed first embodiment of the tank mounting arrangement.

FIG. 4 shows the same tank supporting brackets as in FIG. 3 but with longer straps for securing a tank with a larger diameter.

FIG. 5 is a view of a tank with a larger diameter that is secured by straps to the same supporting brackets mounted in the same location as shown in FIG. 3.

FIG. 6 is a view of a second embodiment of the disclosed arrangement in which the tank is supported on four supporting brackets.

FIG. 7 shows the tank supporting brackets according to the second embodiment and the straps for securing a tank to these supporting brackets.

FIG. 8 is a view of a tank secured by straps to the supporting brackets of the tank mounting arrangement illustrated in FIG. 6.

FIG. 9 shows the tank supporting brackets according to the second embodiment of the present arrangement and the straps for securing a tank with a larger diameter to the supporting brackets, which are mounted in the same location as with the tank in FIGS. 7 and 8.

FIG. 10 is a view of a tank secured by straps to the supporting brackets of the disclosed tank mounting arrangement illustrated in FIG. 6 that was also suitable for mounting the tank with a smaller diameter as shown in FIG. 8.

### DETAILED DESCRIPTION OF PREFERRED EMBODIMENT(S)

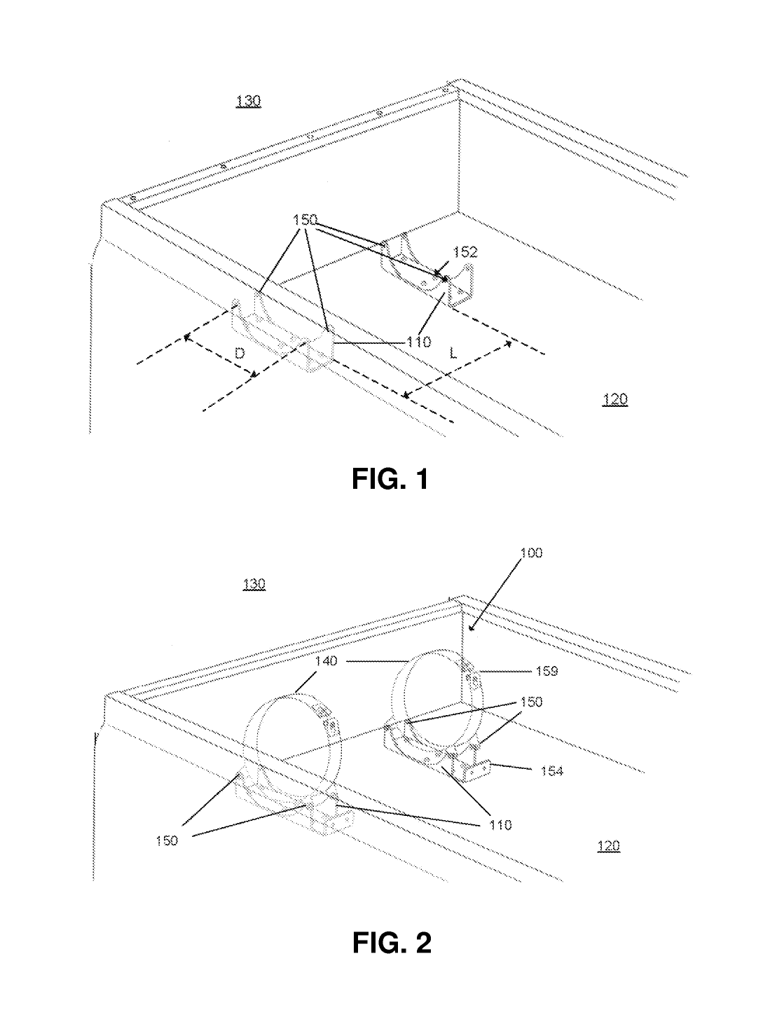

FIG. 1 illustrates two tank supporting structures installed on the floor of a pick-up truck bed for mounting a tank to a vehicle according to a first embodiment of the present arrangement. The two supporting structures are two supporting brackets 110 which are mounted on the vehicle body. In the illustrated embodiments, the vehicle is a pick-up truck and supporting brackets 110 which support the tank are mounted on floor 120 of the pick-up truck bed, preferably behind vehicle cab 130.

The tank can be mounted anywhere in the pick-up truck bed, but for space considerations, convenience reasons and protection purposes, in preferred embodiments, the tank is preferably placed behind vehicle cab 130, as illustrated here.

When mounted in the pick-up truck bed supporting brackets 110 are aligned to each other and distance L between supporting brackets 110 is selected such that the brackets can securely accommodate the installation of a tank in the pick-up truck bed. Distance L can be modified to accommodate tanks of different lengths, but preferably distance L is selected so that the same arrangement can be used for the entire range of tank sizes to be offered to customers. The embodiments described here refer to a supporting structure for a tank installed on the floor of a pick-up truck bed. In preferred embodiments, the tank can be an auxiliary fuel tank, storing for example compressed natural gas (CNG). Nonetheless, the present arrangement can be used for protecting tanks that can be used for other purposes, such as storing other gaseous fuels, liquid fuels, water and other fluids. While tanks can have different cross-sectional shapes, the present embodiments illustrate mounting arrangements adapted to support a cylindrical tank. The relative position of the brackets and their shape and size can be customized according to the shape and size of the tank being installed in the pick-up truck bed.

Tank mounting arrangement 100 illustrated in FIG. 2 comprises supporting brackets 110 and straps 140. As illustrated in FIG. 2, each supporting bracket 110 is connected to a strap 140 in two mounting locations 150.

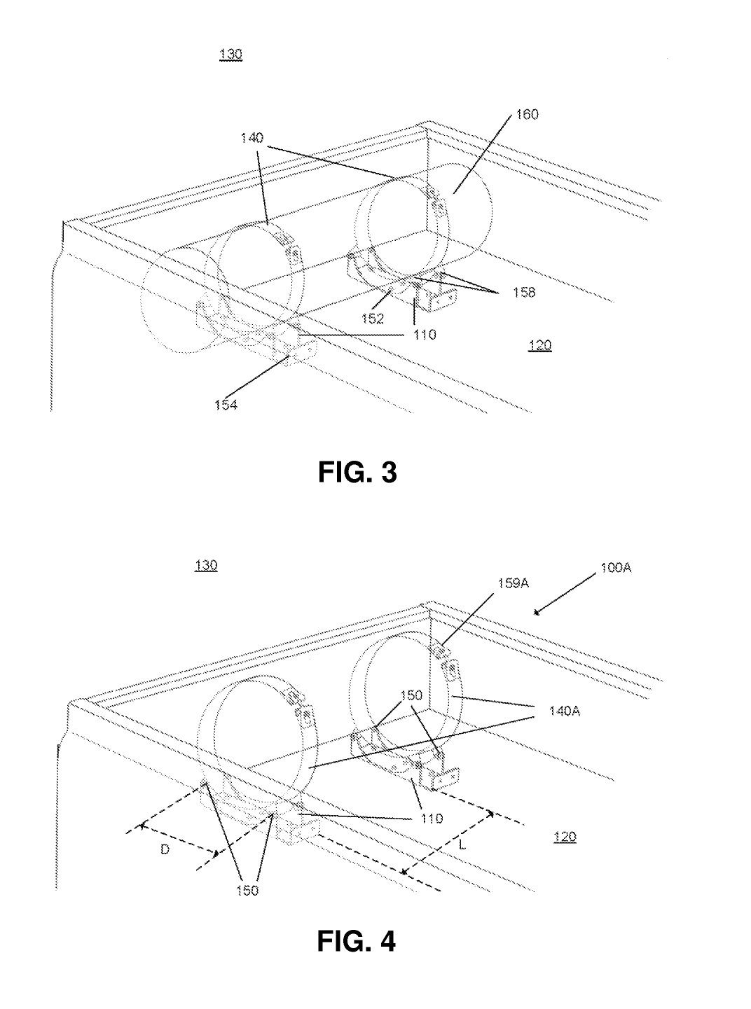

With reference to FIG. 3, tank 160 is securely attached to supporting brackets 110 which are mounted on floor 120 of the pick-up truck bed. Supporting brackets 110 can have different shapes and preferably have a shape that conforms to the tank shape without supporting brackets 110 touching the tank. That is, in the preferred embodiments, the tank is clamped in position by the straps and the tank is spaced apart from the supporting brackets and the vehicle body. The supporting brackets 110 are designed to provide the sturdiness required for supporting the tank when filled and when subjected to the dynamic forces associated with a moving vehicle. Even if the figures illustrate tank 160 being supported by two supporting brackets 110, a different number of supporting brackets could be used to secure the tank in the truck bed, if necessary. Each supporting bracket 110 is attached to floor 120 of the pick-up truck bed through bolts 152. While bolting is the preferred method of mounting the tank supporting brackets on the floor of the pick-up truck bed, other methods of detachably mounting these parts can be used, such as for example using riv-nuts, screws, pop rivets or adhesives. In other embodiments more permanent attachment methods such as welding can be employed. In some embodiments, supporting brackets 110 are secured to the frame of the pick-up truck.

In some figures supporting brackets 110 are illustrated as having an extension 154 which can serve the purpose of attaching a tank enclosure to the pick-up truck bed. An example of such a tank cover is described in co-owned U.S. non-provisional patent application entitled “Multi-Piece Vehicle Tank Enclosure”, which is being filed concurrently herewith.

Straps 140 which encircle tank 160 can be mounted through a set of mounts 158 to supporting brackets 110. In the embodiments illustrated in FIGS. 1-5, each strap 140 encircles the tank and is provided with a set of four mounts 158 which connect strap 140 to a respective supporting bracket 110 at mounting locations 150. Mounts 158 can be part of strap 140, and can be formed during the manufacturing process by bending some portions of the strap such that when straps 140 are installed on supporting brackets 110, mounts 158 can connect with supporting bracket 110.

Mounts 158 of one strap 140 can be connected to a respective supporting bracket 110 at mounting locations 150 through a bolt or pin arrangement, for example. This means of attachment, or equivalent structures, allow some degree of rotation of strap 140 relative to respective supporting bracket 110 at each mounting location 150 which is a feature that allows supporting and securing tanks of different cross-sectional dimensions to the vehicle body without having to replace supporting brackets 110. Distance D between mounting locations 150 for each bracket is fixed.

Straps 140 are kept in a close contact with the tank through tightening devices 159 which can be adjusted to provide an adequate tightening force for keeping tank 160 secured to supporting brackets 110.

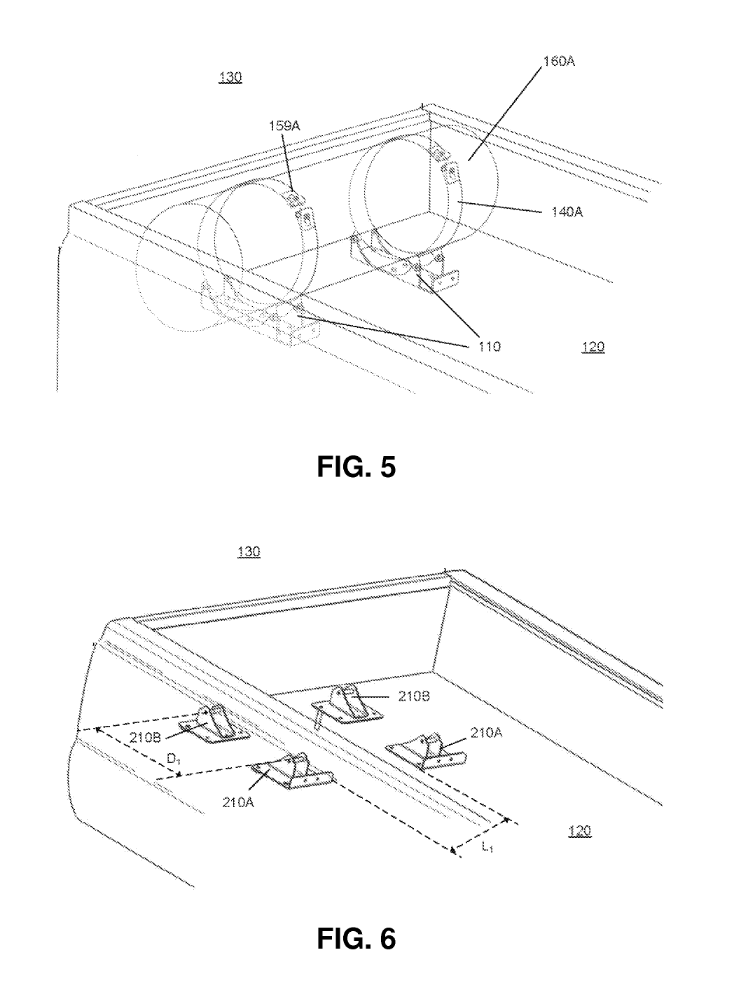

FIGS. 2 and 3 illustrate the mounting arrangement for a small diameter tank 160 which is installed in the pick-up truck bed behind vehicle cab 130. A customer may prefer a smaller tank if vehicle range requirements are modest and there is a desire to use the tank enclosure with a larger tool box bin as described in co-owned U.S. non-provisional patent application entitled “Multi-Piece Vehicle Tank Enclosure”, which is being filed concurrently herewith. Features of supporting brackets 110, such as the elevated mounting locations 150 which are designed with a bolt or pin attachment means to allow some rotation of mounts 158, allow the same supporting structures to be employed to support tanks of different diameters. FIGS. 4 and 5 further illustrate the same supporting structure being employed to support and secure tank 160A which has a larger diameter.

As illustrated in FIG. 4 supporting brackets 110 can be left in the same position as illustrated in FIGS. 1 and 2, more specifically supporting brackets 110 can be mounted on floor 120 of the pick-up truck bed at the same distance L between each other. Because same supporting brackets 110 are employed distance D between mounting locations 150 is maintained the same as in FIGS. 1-3. For larger diameter tanks different straps 140A can be installed on supporting brackets 110 to accommodate a tank 160A as illustrated in FIG. 5. When different straps are used the linear distance along the strap between the mounts can be different to maintain a desired spacing between the bottom of tank 160A and the floor of the pick-up truck bed. Straps 140A are provided with tightening devices 159A which can be adjusted to provide an adequate clamping force for keeping tank 160A secured to supporting brackets 110.

The method for employing the same structural supports for mounting tanks of different cross-sectional dimensions on a vehicle body according to the first embodiment of the present arrangement comprises:
(a) mounting at least one tank strap 140 on supporting bracket 110 which is mounted on the vehicle body wherein the strap is attached at two mounting locations 150 to supporting bracket 110;
(b) placing an elongated tank on the strap and encircling the tank with the strap; and
(c) operating a tightening device 159 to secure the tank to supporting brackets 110.

The method further comprises employing the same straps and the same apparatus to mount tanks with different cross-sectional dimensions. While the same strap could be used for tanks of different sizes, it is preferred to use different straps with different lengths and spacing between mounts 158 to be efficient with the use of material and achieve the desired spacing between the bottom of the tank and bed floor 120.

FIGS. 6-10 illustrate a second embodiment of the present arrangement, in which each tank supporting structure comprises supporting brackets 210A and 210B, which are installed on floor 120 of a pick-up truck bed. Each set of supporting brackets 210A-210B support one end of the tank when it is installed in the pick-up truck bed. Supporting brackets 210A and 210B serve the same purpose as supporting brackets 110 illustrated in FIGS. 1-5.

When mounted in the pick-up truck bed, supporting brackets 210A and 210B are aligned to each other transversally and longitudinally and distance L₁ between the first and second supporting structure, which each comprises supporting brackets 210A and 210B, is selected such that they can securely accommodate the installation of the desired range of tank sizes in the pick-up truck bed. That is, distance L₁ can be chosen to accommodate tanks of different lengths. While tanks can have different cross-sectional shapes, the present embodiments illustrate mounting arrangements adapted to support a cylindrical tank. The relative position of the supporting brackets and their shape and size can be customized according to the shape and size of the tank being installed in the pick-up truck bed. Supporting brackets 210A and 210B can have different shapes and preferably have a shape that provides the sturdiness required for supporting the tank with an elevated mounting location that allows some rotation of mounts 158 when the strap is mounted thereon.

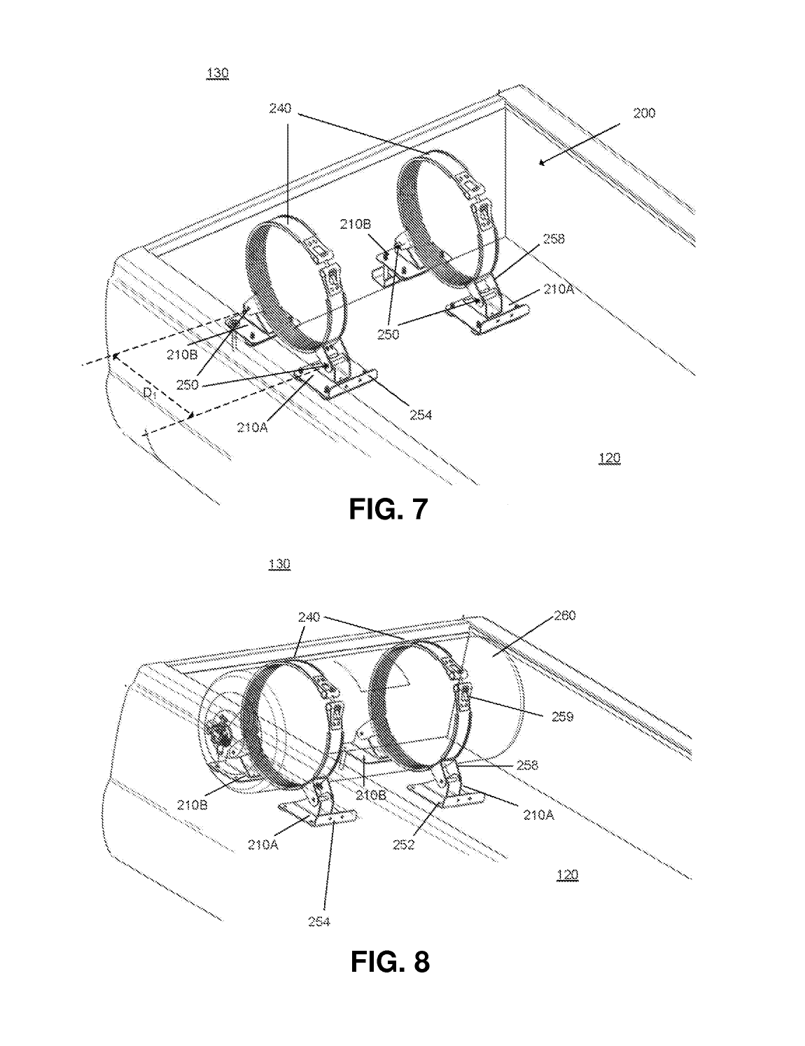

Tank mounting arrangement 200 illustrated in FIG. 7 comprises supporting brackets 210A and 210B and straps 240. Each of the supporting brackets 210A and 210B is connected to a strap 240 in one mounting location 250.

With reference to FIG. 8, tank 260 is securely installed on supporting brackets 210A and 210B which are mounted on floor 120 of the pick-up truck bed. Even if the figures illustrate tank 260 being supported by two supporting structures, each comprising supporting brackets 210A and 210B, a different number of supporting brackets and supporting structures could be used to secure the tank in the truck bed with more straps, if necessary. Supporting brackets 210A and 210B are attached to floor 120 of the pick-up truck bed through bolts 252. In some figures supporting brackets 210A and 210B are illustrated as having an extension 254 which can serve the purpose of attaching a vehicle tank enclosure to the pick-up truck bed. An example of such a tank enclosure is described in co-owned U.S. non-provisional patent application entitled “Multi-Piece Vehicle Tank Enclosure”, which is being filed concurrently herewith.

Straps 240 which encircle tank 260 can be mounted through a set of mounts 258 to supporting brackets 210A, 210B. In the embodiments illustrated in FIGS. 7-10, mounts 258 are U-shaped members, for example U-brackets which are bolted or welded to each strap 240 such that when strap 240 is installed on supporting brackets 210A and 210B these U-shaped members connect the strap with the supporting brackets.

Each mount 258 of each strap 240 which is installed on a respective supporting bracket 210A or 210B can be connected to the bracket at a mounting location 250 for example through a bolt or pin arrangement. This means of attachment advantageously allows some degree of rotation of strap 240 relative to supporting brackets 210A and 210B at mounting location 250 which is a feature that allows supporting and securing tanks of different cross-sectional dimensions to the vehicle body without having to replace supporting brackets 210A and 210B.

In the embodiment illustrated in FIGS. 6-10, distance D₁ between mounting locations 250 for each bracket is fixed at a predetermined distance that will accommodate a range of different tank sizes to be offered to customers.

Straps 240 are clamped onto the tank through tightening devices 259 which can be adjusted to provide an adequate tightening force for keeping tank 260 secured in place when mounted to supporting brackets 210A and 210B.

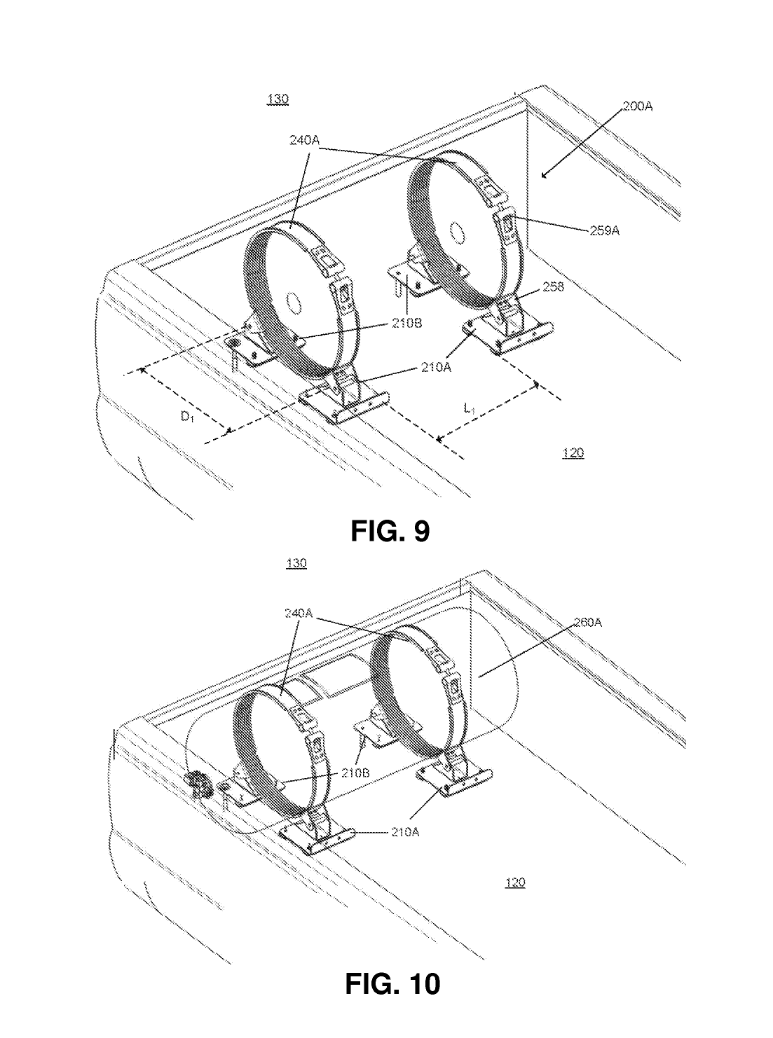

FIG. 8 illustrates the mounting arrangement for small tank 260 which is installed in the pick-up truck bed behind vehicle cab 130. Like with the first embodiment, supporting brackets 210A and 210B can support tanks of different dimensions. FIGS. 9 and 10 further illustrate a similar mounting arrangement for supporting and securing bigger tank 260A on supporting brackets 210A and 210B which are mounted in the pick-up truck bed behind vehicle cab 130.

As illustrated in FIG. 9 supporting brackets 210A and 210B can be left in the same position as illustrated in FIGS. 7 and 8, more specifically keeping the same distance L₁ between the supporting structures comprising supporting brackets 210A and 210B and the same distance D₁ between mounting locations 250. Different straps 240A can be installed on supporting brackets 210 to accommodate a larger tank 260A as illustrated in FIG. 10. Straps 240A are provided with tightening devices 259A which can be adjusted to provide an adequate tightening force for keeping tank 260A secured to supporting brackets 210A and 210B.

The method for employing the some structural supports for mounting tanks of different cross-sectional dimensions on a vehicle body according to the second embodiment of the present arrangement is essentially the same as the disclosed method employed with the first embodiment.

An advantage of the disclosed tank mounting arrangement compared to the existing mounting arrangements is that tanks of different sizes can be installed without having to change the supporting brackets on which the tank is installed. This can be an advantage in production line manufacturing because it reduces customization. In preferred embodiments, and for tank dimensions within a predetermined range, this arrangement allows the same supporting brackets to be used and at the same locations on the vehicle body. It is also advantageous for reducing the number of different parts that need to be kept in inventory and can further reduce manufacturing costs because such costs can typically be reduced when part volumes are higher.

In the above described embodiments illustrated in FIGS. 1-10, the tank is installed on said vehicle body such that the distance between the bottom of the tank and the surface of the vehicle body on which the tank is mounted, for example floor 120 of the pick-up truck bed, is at a predetermined distance. The distance is chosen to be large enough so that the tank will not touch the vehicle body under any operating conditions. If the tank rubs against the vehicle body this can be damaging to the tank, especially if the tank is a composite tank. However it is also desirable to specify a distance that does not result in the tank being too high above the floor as not to interfere with visibility for the vehicle driver. In addition, a higher mounting position can require stronger structural supports and can reduce space available for storage in the truck bed or tank enclosure.

In the first and second embodiments described above, the tank supporting structures have been illustrated respectively as supporting brackets 110 and supporting brackets 210A and 210B. Instead of the illustrated supporting brackets, other structural members having at least a portion that projects from the vehicle body and allows at least one mounting location 150 and respectively 250 to be spaced from the vehicle body, can be used.

While particular elements, embodiments and applications of the present invention have been shown and described, it will be understood, that the invention is not limited thereto since modifications can be made by those skilled in the art without departing from the scope of the present disclosure, particularly in light of the foregoing teachings. For example, the two supporting brackets shown in the first embodiment illustrated in FIGS. 1-5 could be made as a single bracket designed to be used with two straps with mounting points in substantially the same positions, or a single bracket could be used with a single wider strap. In addition, if the vehicle frame is not located in the locations where the structural supports are to be mounted, a structural plate can be added between the structural support and the frame to transfer the load from the structural supports to the frame.

What is claimed is:

1. A tank mounting arrangement for a vehicle, said mounting arrangement comprising at least one supporting structure mounted on the vehicle body adjustable to support tanks of different cross-sectional dimensions, each supporting structure connected to a strap in two mounting locations spaced transversal to a longitudinal axis of a tank, wherein said strap encircles said tank to secure said tank to said supporting structure.

2. The tank mounting arrangement of claim 1, wherein each of said supporting structures comprises at least one member having a portion projecting from said vehicle body whereby at least one of said mounting locations is spaced from said vehicle body.

3. The tank mounting arrangement of claim 2, wherein said mounting locations are spaced from the vehicle body, whereby said strap is in contact with the entire circumference of said tank and said tank is held spaced from the vehicle body.

4. The tank mounting arrangement of claim 1, wherein each of said straps comprises a mount extending radially from said tank when said tank is mounted on said supporting structure for connecting said strap to each mounting location.

5. The tank mounting arrangement of claim 4, wherein each of said mounts has a U-shaped cross-section.

6. The tank mounting arrangement of claim 1, wherein each of said straps is connected to a respective supporting structure through mounts that allow rotation of said strap relative to said supporting structures at said mounting location, thereby accommodating tanks of differing cross-sectional dimensions.

7. The tank mounting arrangement of claim 6, wherein said rotation at said mounting location is provided by each of said mounts comprising a U-shaped member and one of a bolt and a pin connecting said U-shaped member to said tank supporting structure.

8. The tank mounting arrangement of claim 1, wherein each of said straps comprises a tightening device for tensioning said strap to secure said tank on said supporting structure.

9. The tank mounting arrangement of claim 1, wherein when said tank is installed on said vehicle body, a distance between said tank bottom and a surface of said vehicle body on which said tank is mounted is greater than a minimum predetermined distance.

10. The tank mounting arrangement of claim 1, wherein said tank is a pressure vessel for storing an auxiliary fuel.

11. The tank mounting arrangement of claim 1, wherein said supporting structures are secured to structural members of a frame of said vehicle.

12. The tank mounting arrangement of claim 11, wherein said tank is located in said vehicle bed.

13. The tank mounting arrangement of claim 1, wherein a distance between said supporting structures mounted on the vehicle body is selected to accommodate tanks of different lengths.

14. The tank mounting arrangement of claim 1, wherein said supporting structure is shaped to be spaced apart from said tank, whereby said strap is in contact with said tank and not in contact with said supporting structure.

15. A method of using an apparatus for mounting on a vehicle body tanks of differing cross-sectional dimensions, the method comprising:
(a) detachably mounting at least one tank strap on at least one supporting structure which is mounted on said vehicle body wherein said strap is mounted in two mounting locations on said supporting structure;
(b) placing a tank on said strap and wrapping said strap around said tank, whereby said tank strap can rotate at said mounting locations to conform to the shape of said tank;
(c) operating a tightening device associated with said strap to tighten said strap and secure said tank in a mounted position; and
(d) carrying out the steps (a)-(c) above using the same supporting structure to mount a tank with a different cross-sectional dimension.

16. The method of claim 15, further comprising using different straps for different tank sizes, whereby said strap length is matched to the circumference of the tank.

17. The method of claim 15, further comprising using different straps for different tank sizes, whereby linear spacing between mounts is matched to tank size such that a desired spacing is achieved between the bottom of said tank and vehicle body.
